(19) United States
(12) Patent Application Publication
(10) Pub. No.: US 2017/0275433 A1
(43) Pub. Date: Sep. 28, 2017

(54) EXPANDABLE STYRENE-COMPOUNDED POLYOLEFIN RESIN PARTICLES, METHOD FOR PRODUCING SAME, PRE-EXPANDED PARTICLES, AND EXPANSION MOLDED ARTICLE

(71) Applicant: SEKISUI PLASTICS CO., LTD., Osaka (JP)

(72) Inventors: Shingo TERASAKI, Shiga (JP); Naoya MORISHIMA, Shiga (JP)

(73) Assignee: SEKISUI PLASTICS CO., LTD., Osaka (JP)

(21) Appl. No.: 15/512,358

(22) PCT Filed: Sep. 16, 2015
(86) PCT No.: PCT/JP2015/076305

§ 371 Date: Mar. 17, 2017

(30) Foreign Application Priority Data
Sep. 26, 2014 (JP) 2014-197005

(51) Int. Cl. C08J 9/18; C08J 9/00; C08J 9/14

(52) U.S. Cl. CPC C08J 9/18; C08J 9/141; C08J 9/0061; C08J 9/0066; C08J 2203/14; C08J 2325/06; C08J 2423/06

(57) ABSTRACT

Expandable styrene composite polyolefin-based resin particles which comprise styrene composite polyolefin-based resin particles containing a polyolefin-based resin and 100 to 400 parts by mass of a styrene-based resin with respect to 100 parts by mass of the polyolefin-based resin and comprise butane/pentane in a mass ratio of 80/20 to 50/50 as a volatile blowing agent.

### TECHNICAL FIELD

The present invention relates to expandable styrene-compounded polyolefin resin particles (expandable styrene composite polyolefin-based resin particles) and a method for producing the same, pre-expanded particles and an expansion molded article (expanded molded article). More specifically, the present invention relates to expandable styrene composite polyolefin-based resin particles that can realize both good moldability (molding cycle) and life of expanded particles and a method for producing the same, pre-expanded particles and an expanded molded article.

### BACKGROUND ART

Expanded molded articles comprising a polystyrene-based resin have been frequently used as packaging materials or thermal insulating materials because such expanded molded articles have excellent shock-absorbing and thermal insulating properties and are readily formable. These expanded molded articles are, however, insufficient in impact resistance and in plasticity and thus become cracked or chipped easily; therefore, these expanded molded articles are not suited for packaging some items such as precision apparatuses.

On the other hand, expanded molded articles comprising a polyolefin-based resin such as polyethylene are excellent in impact resistance and in plasticity but require large-scale equipment at the time of molding these expanded molded articles. Moreover, because of its properties, the polyolefin-based resin needs to be transported in the form of pre-expanded particles from a raw material maker to a molding and processing maker. Since the pre-expanded particles that are bulky need to be transported, some problems arise such as high production costs.

Because of these reasons, various styrene modified polyolefin-based resin particles (polystyrene-based modified resin particles) which have the merits of the above-described two resins and expanded molded articles using these resin particles have been suggested.

For example, Japanese Patent No. 4809730 (Patent Document 1) discloses styrene modified polyolefin-based resin particles containing 20 to 600 parts by mass of a styrene-based resin with respect to 100 parts by mass of a polyolefin-based resin, wherein the polyolefin-based resin is an ethylene homopolymer or a copolymer of ethylene with an olefin having 3 or more carbon atoms and the styrene modified polyolefin-based resin particles have a density of 0.940 g/cm³ or more, a shrinkage factor (g′ value) of less than 1.0 and 0.4 or more and a melt flow rate of 0.15 to 20 g/10 min upon application of a 2.16 kg load and satisfy the relationship of the formula: MS>110−100×log(MFR) (in the formula, MS is a melt tension (mN) at 160° C. and MFR is a melt flow rate); expandable resin particles; pre-expanded particles; and an expanded molded article.

Patent Document 1 has an object to provide styrene modified polyolefin-based resin particles that can provide an expanded molded article having improved properties such as fusion ratio, rigidity, impact resistance and chemical resistance and the object is achieved by the configuration described above.

Japanese Unexamined Patent Application Publication No. 2010-24353 (Patent Document 2) discloses styrene modified polyolefin-based resin particles containing a polyolefin-based resin (specialty polyethylene) which is formed by a repeating unit derived from ethylene alone or together with a repeating unit derived from α-olefin having 3 to 8 carbon atoms and satisfies the following requirements: (A) a density [d(kg/m³)] of 910 to 950 inclusive, (B) a melt flow rate [MFR] of 0.1 to 20 inclusive, (C) the number of terminal vinyl of 0.2 or less per 1000 carbon atoms, (D) the relationship between the melt tension [MS160] and MFR of MS160>90−130×log(MFR), (E) the relationship between the melt tension [MS190] and MS160 of MS160/MS190<1.8 and (F) having 2 or more peaks in an elution temperature-elution amount curve by temperature rising elution fractionation; expandable resin particles thereof; pre-expanded particles; and an expanded molded article.

Patent Document 2 has an object to provide styrene modified polyolefin-based resin particles that can provide an expanded molded article satisfying both fusion property and thermal resistance and the object is achieved by the configuration described above.

Patent Document 2 also discloses that a volatile blowing agent is used such as propane, n-butane, isobutane, pentane, isopentane, cyclopentane, hexane, dimethyl ether or a mixture of two or more of the foregoing and the preferable content thereof is 5 to 25 parts by mass with respect to 100 parts by mass of styrene modified polyolefin-based resin particles.

Further, Japanese Unexamined Patent Application Publication No. 2011-256244 (Patent Document 3) discloses expandable modified resin particles which comprise a continuous phase containing an ethylene-based resin as a main component in which a dispersed phase having a volume average diameter of 0.55 μm or more and containing a styrene-based resin as a main component and comprise a modified resin, as a base resin, containing the ethylene-based resin and the styrene-based resin at specific proportions and a physical blowing agent, wherein the dispersed phase contains a specific amount of a dispersed phase enlarging agent formed by a thermoplastic polymer and the resin particles have an absorbance ratio (D₆₉₈/D₂₈₅₀) in the range of 0.4 to 5.0 obtained from an infrared absorption spectrum measured by total reflectance infrared spectrometry.

Patent Document 3 has an object to provide expandable modified resin particles and modified resin expanded particles which have excellent retention of a blowing agent and retains excellent persistence which is characteristic to an ethylene-based resin after expansion and molding while being able to provide a molded article having an excellent strength and the object is achieved by the configuration described above.

Patent Document 3 discloses that as a blowing agent, a volatile organic compound having a boiling point of 80° C. or lower is used such as a saturated hydrocarbon compound including methane, ethane, propane, n-butane, isobutane, cyclobutane, n-pentane, isopentane, neopentane, cyclopentane, n-hexane, cyclohexane and the like; a lower alcohol including methanol, ethanol and the like; an ether compound including dimethyl ether, diethyl ether and the like; or a mixture of two or more of the foregoing, and that the preferable content thereof is 2 to 10 parts by mass with respect to 100 parts by mass of the modified resin.

Patent Document 3 also discloses that, because the physical blowing agent can be satisfactorily immersed and retained in the modified resin particles, the physical blowing agent preferably comprises 30 to 100% by mass of isobutane and 0 to 70% by mass (total: 100% by mass) of a hydrocarbon having 4 to 6 carbon atoms, that in order to improve retention of the blowing agent in the resin particles, the proportion of isobutane in the physical blowing agent is preferably 30% by mass or more, that in order to improve retention of the blowing agent in the modified resin particles, improve the expansion power during molding and improve fusion of expanded particles in the molded article, the hydrocarbon having 4 to 6 carbon atoms is preferably normal butane, isobutane, normal pentane, isopentane, neopentane, normal hexane, 2-methylpentane, 3-methylpentane, 2,2-dimethylbutane, 2,3-dimethylbutane, cyclobutane, cyclopentane, cyclohexane and the like.

### CITATION LIST

### Patent Literatures

Patent Document 1: Japanese Patent No. 4809730

Patent Document 2: Japanese Unexamined Patent Application Publication No. 2010-24353

Patent Document 1: Japanese Unexamined Patent Application Publication No. 2011-256244

### SUMMARY OF INVENTION

### Technical Problems

Expandable styrene composite polyolefin-based resin particles, particularly the resin particles in which the polyolefin-based resin is high-density polyethylene have issues such that a residual blowing agent tends to remain in pre-expanded particles and the set steam pressure during molding needs to be high in order to fuse pre-expanded particles due to high melting point thereof. From two reasons above, it is a problem that expanded molded articles obtained tend to have a long molding cycle, although the articles have characteristic low temperature dependency.

In addition, expandable styrene composite polyolefin-based resin particles, particularly expandable styrene composite polyethylene-based resin particles are transported to a molding maker after immersion and extraction of a blowing agent immediately followed by expansion and storage in the form of pre-expanded particles because of high fugacity of the blowing agent. In order to be operable in the production process, it is required that the resin particles can be molded anytime during 1 month after expansion, and thus the pre-expanded particles are required to contain a certain amount of blowing agent even after 1 month (the life of expanded particles). However, in early days after expansion, the pre-expanded particles contain an excess amount of blowing agent, resulting in such problems that the secondary expansion force is excessively high and the molding cycle is extended.

As a blowing agent for expandable styrene composite polyolefin-based resin particles, particularly expandable styrene composite polyethylene-based resin particles, butane or isopentane is suggested in many patent documents as well as frequently used practically. However, such a blowing agent has the following issues:

(1) When butane is used as a blowing agent, expanded particles have high secondary expansion force and thus a 1-month life of expanded particles can be maintained. However, in early days after expansion, the surface pressure during molding is excessively high, causing an extension of the molding cycle.

(2) When isopentane is used as a blowing agent for the purpose of freezing expandable resin particles, the expanded particles have suppressed secondary expansion force, and thus an increment of the surface pressure tends to be small during molding, causing shortening of the molding cycle; however, the life of expanded particles cannot be maintained for 1 month.

Namely, it is difficult to achieve prevention of an extension of the molding cycle in early days after expansion and maintenance of the life of expanded particles for 1 month by using butane or pentane as a blowing agent.

Thus, an object of the present invention is to solve the above problems and provide expandable styrene composite polyolefin-based resin particles that can realize both good moldability (molding cycle) and life of expanded particles and a method for producing the same, pre-expanded particles and an expanded molded article.

### Solution to Problems

As a result of considerable deliberation, the inventors of the present invention found that by using butane having high secondary expansion force and pentane having low secondary expansion force at a specific proportion, expandable styrene composite polyolefin-based resin particles having both good moldability (molding cycle) and life of expanded particles can be obtained, and achieved the present invention.

The background art described above merely discloses examples of use of butane alone or pentane alone as a blowing agent and does not specifically disclose a combined use of butane and pentane at a specific addition ratio in order to achieve both good moldability (high-cycle) and life of expanded particles.

The present invention, therefore, provides expandable styrene composite polyolefin-based resin particles which comprise styrene composite polyolefin-based resin particles containing a polyolefin-based resin and 100 to 400 parts by mass of a styrene-based resin with respect to 100 parts by mass of the polyolefin-based resin and comprise butane/pentane in a mass ratio of 80/20 to 50/50 as a volatile blowing agent.

The present invention also provides:

pre-expanded particles obtained by expanding the expandable styrene composite polyolefin-based resin particles;

an expanded molded article obtained by expansion molding of the pre-expanded particles; and

a method for producing the expandable styrene composite polyolefin-based resin particles, comprising immersing butane/pentane in a mass ratio of 80/20 to 50/50 as a volatile blowing agent in the styrene composite polyolefin-based resin particles.

### Advantageous Effects of Invention

The present invention can provide expandable styrene composite polyolefin-based resin particles that can realize both good moldability (molding cycle) and life of expanded particles and a method for producing the same, pre-expanded particles and an expanded molded article.

The expandable styrene composite polyolefin-based resin particles of the present invention further exert the above-described excellent effects in the case where the expandable styrene composite polyolefin-based resin particles meet at least one of the following conditions:

(1) the volatile blowing agent is contained at a proportion of 9 to 18% by mass with respect to the styrene composite polyolefin-based resin;

(2) the volatile blowing agent is a mixture of butane selected from n-butane and isobutene, and pentane selected from n-pentane, isopentane and neopentane;

(3) a content of insoluble gel when about 1 g of the styrene composite polyolefin-based resin particles is dissolved in 100 ml of refluxed toluene is less than 5% by mass;

(4) the styrene composite polyolefin-based resin particles have an average particle diameter of 1.0 to 2.0 mm; and

(5) the polyolefin-based resin is formed with a first polyethylene-based resin having medium density to high density in the range of 925 to 965 kg/m³ and a second linear polyethylene-based resin having a density that is lower than that of the first polyethylene-based resin.

The present invention further exhibits an additional effect, in addition to the excellent effects described above, of obtaining black expandable styrene composite polyolefin-based resin particles when the styrene composite polyolefin-based resin particles contain 0.5 to 2.5% by mass of carbon black as a coloring agent with respect to the styrene composite polyolefin-based resin.

### DESCRIPTION OF EMBODIMENTS

### [Expandable Styrene Composite Polyolefin-Based Resin Particles]

Expandable styrene composite polyolefin-based resin particles (hereinafter also referred to as “expandable resin particles”) of the present invention comprise styrene composite polyolefin-based resin particles (hereinafter also referred to as “composite resin particles”) containing a polyolefin-based resin and 100 to 400 parts by mass of a styrene-based resin with respect to 100 parts by mass of the polyolefin-based resin and comprise butane/pentane in the mass ratio of 80/20 to 50/50 as a volatile blowing agent (also merely referred to as a “blowing agent”).

### [Volatile Blowing Agent]

The expandable resin particles of the present invention comprise butane/pentane in the mass ratio of 80/20 to 50/50 as a volatile blowing agent.

As butane, n-butane, isobutane and cyclobutane may be mentioned and among these, butane selected from n-butane and isobutane is preferable in view of versatility and availability.

As pentane, n-pentane, isopentane, neopentane and cyclopentane may be mentioned and among these, pentane selected from n-pentane, isopentane and neopentane is preferable in view of versatility and availability.

The butane/pentane is particularly preferably a mixture of isobutane/n-pentane as isobutane tends to remain in pre-expanded particles and can extend the life of expanded particles and n-pentane has low secondary expansion force and can shorten the molding cycle.

If the mass ratio of butane/pentane as the volatile blowing agent exceeds 80/20, namely the proportion of butane is increased, the secondary expansion force may be too high and the molding cycle may be extended in early days after expansion. On the other hand, if the mass ratio of butane/pentane as the volatile blowing agent is less than 50/50, namely the proportion of pentane is increased, the secondary expansion force may be too low and the life of expanded particles for a month may not be maintained.

The mass ratio of butane/pentane as the volatile blowing agent is, for example, 80/20, 75/25, 70/30, 65/35, 60/40, 55/45 or 50/50.

The mass ratio of butane/pentane as the volatile blowing agent is preferably 70/30 to 50/50.

It is desirable that the volatile blowing agent is contained at a proportion of 9 to 18% by mass with respect to the composite resin particles.

If the addition proportion of the volatile blowing agent is less than 9% by mass, the expandability during expansion of pre-expanded particles may decrease. On the other hand, if the addition proportion of the volatile blowing agent exceeds 18% by mass, the cells in the pre-expanded particles may become too coarse.

The addition proportion (% by mass) of the volatile blowing agent is, for example, 9, 9.5, 10, 10.5, 11, 11.5, 12, 12.5, 13, 13.5, 14, 14.5, 15, 15.5, 16, 16.5, 17, 17.5 or 18.

The addition proportion of the volatile blowing agent is more preferably 10.5 to 18% by mass and still more preferably 11 to 15% by mass.

### [Styrene Composite Polyolefin-Based Resin Particles]

The composite resin particles forming the expandable resin particles of the present invention contain a polyolefin-based resin and 100 to 400 parts by mass of a styrene-based resin with respect to 100 parts by mass of the polyolefin-based resin.

As the composite resin particles, there may be mentioned mixed resin particles of a polyolefin-based resin and a styrene-based resin, for example, resin particles having modified resin properties obtained by seed polymerization in which a styrene-based monomer is immersed in seed resin particles comprising a polyolefin-based resin and polymerized.

### [Polyolefin-Based Resin]

As the polyolefin-based resin, a homopolymer or copolymer of an α-olefin having 2 to 8 carbon atoms may be mentioned.

As the α-olefin having 2 to 8 carbon atoms, ethylene, propylene, 1-butene, 1-hexene, 1-octene, 4-methyl-1-pentene, 3-methyl-1-butene, vinylcycloalkanes (such as vinylcyclopentane and vinylcyclohexane), cyclic olefins (such as norbornene and norbornadiene), dienes (such as butadiene and 1,4-hexadiene) may be mentioned.

Among these, an ethylene homopolymer and a copolymer of ethylene and an α-olefin having 3 to 8 carbon atoms, a propylene homopolymer and a copolymer of propylene and an α-olefin having 4 to 8 carbon atoms are preferable in view of an improvement in impact resistance of the expanded molded article.

More specifically, a mixture of a medium- to high-density polyethylene and a linear low-density polyethylene at a proportion of 100/0 to 60/40, which is used in Examples, may be mentioned.

More specifically, the polyolefin-based resin is preferably a resin formed with a first polyethylene-based resin having medium to high density in the range of 925 to 965 kg/m³, preferably 930 to 950 kg/m³ and a second linear polyethylene-based resin having a density that is lower than that of the first polyethylene-based resin.

It is desirable that the resin contains the first polyethylene-based resin and the second polyethylene-based resin in the ranges of 90 to 30% by mass and 10 to 70% by mass, respectively, with respect to the sum of the resins. In this case, it is desirable that the contents of the polyolefin-based resin and the polystyrene-based resin are in the ranges of 50 to 20% by mass and 50 to 80% by mass, respectively, with respect to the sum of the polyolefin-based and polystyrene-based resins.

It is also desirable that the resin is such that the first polyethylene-based resin has a number average molecular weight Mn in terms of polystyrene in the range of 25,000 to 50,000, a Z-average molecular weight Mz in the range of 700,000 to 1,300,000 and Mz/Mn in the range of 20 to 50.

### [Styrene-Based Resin]

As the styrene-based resin, a polymer of a styrene-based monomer and a polymer of a monomer mixture containing a styrene-based monomer may be mentioned.

As a polymer of a styrene-based monomer, there are no particular limitations so long as it is a resin containing a styrene-based monomer as a main component, and a homopolymer or copolymer of styrene or a styrene derivative may be mentioned.

As styrene derivatives, α-methylstyrene, vinyl toluene, chlorostyrene, ethylstyrene, isopropylstyrene, dimethylstyrene, bromostyrene, and the like monofunctional monomers may be mentioned. These styrene-based monomers may be used alone or may be combined.

As a polymer of a monomer mixture containing a styrene-based monomer, a polymer in which a vinyl-based monomer copolymerizable with a styrene-based monomer is combined may be mentioned.

As the vinyl-based monomer, for example, multifunctional monomers such as divinylbenzenes such as o-divinylbenzene, m-divinylbenzene, and p-divinylbenzene, and alkylene glycol di(meth)acrylates such as ethylene glycol di(meth)acrylate and polyethylene glycol di(meth)acrylate; (meth)acrylonitrile; methyl (meth)acrylate; butyl (meth)acrylate; and the like may be mentioned. Among these, multifunctional monomers are preferable, ethylene glycol di(meth)acrylate, polyethylene glycol di(meth)acrylates in which the number of ethylene units is 4 to 16, and divinylbenzenes are more preferable, and divinylbenzenes and ethylene glycol di(meth)acrylate are particularly preferable. The monomers may be used alone or may be combined.

Also, when the monomer is used in combination, it is desirable that the content thereof is set so that the styrene-based monomer becomes the main component (for example, 50% by mass or more).

In the present invention, “(meth)acryl” means “acryl” or “methacryl.”

### [Combining Ratio of the Resin]

A polymer of a styrene-based monomer or a polymer of a monomer mixture containing a styrene-based monomer (hereinafter also referred to as a “styrene-based polymer”) in the composite resin is 100 to 400 parts by mass with respect to 100 parts by mass of the polyolefin-based resin.

If the styrene-based polymer is less than 100 parts by mass, rigidity of an expanded molded article may decrease. On the other hand, if the styrene-based polymer exceeds 400 parts by mass, impact resistance of an expanded molded article may be insufficient.

The styrene-based polymer (parts by mass) with respect to 100 parts by mass of the polyolefin-based resin is, for example, 100, 125, 150, 175, 200, 225, 250, 300, 350, 400, 450, 500, 650, 700, 750 or 800.

It is desirable that the styrene-based polymer is 150 to 250 parts by mass with respect to 100 parts by mass of the polyolefin-based resin.

### [Properties of Composite Resin Particles]

The composite resin particles preferably have a content of insoluble gel when about 1 g of the composite resin particles is dissolved in 100 ml of refluxed toluene of less than 5% by mass.

If the content of gel of the composite resin particles is 5% by mass or more, expandability during expansion of pre-expanded particles may decrease. The lower limit of the content of gel is about 0.2% by mass.

The content (% by mass) of gel of the composite resin particles is, for example, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2, 2.5, 3, 3.5, 4, 4.5 or 5.

How to measure the content will be detailed in Examples.

The composite resin particles preferably have an average particle diameter of 1.0 to 2.0 mm.

If the composite resin particles have an average particle diameter of less than 1.0 mm, retention of the blowing agent may decrease when the composite resin particles are used for expandable particles and it may be difficult to reduce the density. On the other hand, if the composite resin particles have an average particle diameter of more than 2.0 mm, filling property to a mold may deteriorate when the composite resin particles are used for pre-expanded particles and it may be difficult to make a thin expanded molded article.

The average particle diameter (mm) of the composite resin particles is, for example, 1.0, 1.1, 1.2, 1.3, 1.4, 1.5, 1.6, 1.7, 1.8, 1.9 or 2.0.

The average particle diameter of the composite resin particles is more preferably 1.2 to 1.5 mm.

The composite resin particles contain the polystyrene-based resin and the polyethylene-based resin. The polystyrene-based resin in the composite resin particles preferably has a Z-average molecular weight Mz measured by GPC in the range of 600×10³ to 1,000×10³.

If the Z-average molecular weight of the composite resin particles is less than 600×10³, an expanded molded article may have a decreased strength and it is not preferable. On the other hand, if the Z-average molecular weight of the composite resin particles exceeds 1,000×10³, pre-expanded particles may have a decreased secondary expandability, fusion properties of pre-expanded particles may deteriorate and an expanded molded article may have a decreased strength and it is not preferable.

The Z-average molecular weight of the composite resin particles is, for example, 600×10³, 650×10³, 700×10³, 725×10³, 750×10³, 775×10³, 800×10³, 825×10³, 850×10³, 875×10³, 900×10³, 950×10³ or 1,000×10³.

The composite resin particles more preferably have a Z-average molecular weight of 700×10³ to 900×10³.

The polystyrene-based resin of the composite resin particles preferably has a mass average molecular weight Mw measured by GPC in the range of 250×10³ to 450×10³.

If the composite resin particles have a mass average molecular weight of less than 250×10³, an expanded molded article may have a decreased strength and it is not preferable. On the other hand, if the composite resin particles have a mass average molecular weight of more than 450×10³, pre-expanded particles may have a decreased secondary expandability, fusion properties of pre-expanded particles may deteriorate and an expanded molded article may have a decreased strength and it is not preferable.

The mass average molecular weight of the composite resin particles is, for example, 250×10³, 275×10³, 300×10³, 310×10³, 320×10³, 330×10³, 340×10³, 350×10³, 360×10³, 370×10³, 380×10³, 390×10³, 400×10³, 425×10³ or 450×10³.

The mass average molecular weight of the composite resin particles is more preferably 300×10³ to 400×10³.

### [Additives]

The composite resin particles of the present invention may comprise additives such as a coloring agent, a flame retardant, a flame-retardant auxiliary agent, a plasticizer, a binding inhibitor, a cell regulator, a crosslinking agent, a filler, a lubricant, a fusion accelerator, an antistatic agent, and a spreader, as long as the additives do not deteriorate any properties.

The additives may be added to a reaction solution during a polymerization step.

As the coloring agent, carbon black such as furnace black, Ketjenblack, channel black, thermal black, acetylene black, graphite and carbon fiber may be mentioned, which may be a master batch added to a resin.

The composite resin particles of the present invention preferably comprise, as a coloring agent, 0.5 to 2.5% by mass of carbon black with respect to the composite resin.

If the content of the coloring agent in the composite resin particles is less than 0.5% by mass, blackness of an expanded molded article may become insufficient. On the other hand, if the content of the coloring agent in the composite resin particles exceeds 2.5% by mass, the impact resistance of an expanded molded article may decrease.

The content (% by mass) of the coloring agent in the composite resin particles is, for example, 0.5, 1.0, 1.5, 2.0 or 2.5.

As the flame retardant, bromine-based flame retardants such as tri(2,3-dibromopropyl) isocyanate, bis[3,5-dibromo-4-(2,3-dibromopropoxy) phenyl] sulfone, tetrabromocyclooctane, hexabromocyclododecane, trisdibromopropylphosphate, tetrabromobisphenol A, tetrabromobisphenol A-bis(2,3-dibromo-2-methylpropyl ether) and tetrabromobisphenol A-bis(2,3-dibromopropyl ether) may be mentioned.

The content of the flame retardant in the composite resin particles is preferably 1.5 to 6.0% by mass.

As the flame-retardant auxiliary agent, organic peroxides such as 2,3-dimethyl-2,3-diphenyl butane, 3,4-dimethyl-3,4-diphenyl hexane, dicumyl peroxide and cumene hydroperoxide may be mentioned.

The content of the flame-retardant auxiliary agent in the composite resin particles is preferably 0.1 to 2.0% by mass.

The composite resin particles may comprise a plasticizer whose boiling point exceeds 200° C. at 1 atm so as to maintain good expanding moldability even if a pressure of steam is low at the time of the heating and expanding.

As the plasticizer, phthalic esters; glycerin fatty acid esters such as glycerin diacetomonolaurate, glycerin tristearate, and glycerin diacetomonostearate; adipic acid esters such as diisobutyl adipate; coconut oil; and the like may be mentioned.

The content of the plasticizer in the composite resin particles is desirably 0.1 to 3.0% by mass.

As the binding inhibitor, calcium carbonate, silica, zinc stearate, aluminum hydroxide, ethylene bis stearamide, tribasic calcium phosphate, dimethyl silicone, and the like may be mentioned.

As the cell regulator, ethylene bis stearamide, polyethylene wax, and the like may be mentioned.

As the crosslinking agent, organic peroxides such as 2,2-di-t-butyl peroxybutane, 2,2-bis(t-butylperoxy)butane, dicumyl peroxide, 2,5-dimethyl-2,5-di-t-butyl peroxyhexane, and the like may be mentioned.

As the filler, synthetic or naturally-produced silicon dioxide and the like may be mentioned.

As the lubricant, paraffin wax, zinc stearate, and the like may be mentioned.

As the fusion accelerator, stearic acid, stearic acid triglycerides, hydroxystearic acid triglycerides, stearic acid sorbitan esters, polyethylene wax, and the like may be mentioned.

As the antistatic agent, polyoxyethylene alkylphenol ethers, stearic acid monoglycerides, polyethylene glycol, and the like may be mentioned.

As the spreader, polybutene, polyethylene glycol, silicone oil, and the like may be mentioned.

### [Method for Producing Composite Resin Particles]

The method for producing the composite resin particles is not particularly limited and a method for mixing both resins mentioned above and a seed polymerization method may be mentioned, for example.

When using a seed polymerization method, the composite resin particles may be generally obtained by allowing seed particles to absorb a monomer mixture and polymerizing the monomer mixture after or during absorbance. The expandable resin particles may be obtained by immersing a blowing agent in the composite resin particles after or during polymerization.

When a flame retardant or a flame-retardant auxiliary agent is added to the resin particles, the flame retardant or the flame-retardant auxiliary agent may be added during polymerization of the monomer mixture or may be allowed to immerse in the composite resin particles after completion of polymerization.

An example of a method for producing the composite resin particles by seed polymerization is as follows:

First of all, a monomer mixture comprising polyolefin-based resin particles which serve as seed particles are allowed to absorb a monomer of a styrene-based resin (hereinafter also referred to as a “styrene-based monomer”) and the monomer mixture is polymerized after or during absorption to obtain the composite resin particles.

The monomer mixture may be such that all monomers included therein may not be added at the same time to an aqueous medium and all or some monomers may be added to an aqueous medium at different times. When a flame retardant or a flame-retardant auxiliary agent is added to the composite resin particles, the flame retardant or the flame-retardant auxiliary agent may be added to a monomer mixture or an aqueous medium or may be contained in seed particles.

The average particle diameter of the polyolefin-based resin particles which serve as seed particles may be properly adjusted according to the average particle diameter of the composite resin particles to be produced.

The particle diameter of the seed particles ranges preferably from 0.5 to 1.5 mm and more preferably from 0.6 to 1.0 mm. The average mass of the seed particles is around 30 to 90 mg per 100 particles.

Examples of a shape of the seed particles include sphere-shaped, oval-shaped (egg-shaped), cylindrical, and prismatic.

The seed particles may be produced by any publicly known method without particular limitations. For example, the seed particles may be produced by a method in which a raw material resin is melted in an extruder and granulated pellets are obtained by strand cutting, underwater cutting, hot cutting and the like or a method in which resin particles are directly ground in a grinder to obtain pellets.

The particles obtained by the above methods may be appropriately sieved to classify into particles having desired average particle diameters. By using classified seed particles, it is possible to obtain expandable resin particles having a narrow particle distribution and a desired particle diameter.

As the aqueous medium, water and a mixed medium of water with an aqueous solvent (for example, a lower alcohol such as methyl alcohol and ethyl alcohol) may be mentioned.

The aqueous medium may contain a dispersant in order to stabilize dispersion of monomer mixture droplets and seed particles. As such dispersant, for example, organic dispersants such as partially saponified polyvinyl alcohol, polyacrylate salts, polyvinyl pyrrolidone, carboxymethyl cellulose and methyl cellulose; and inorganic dispersants such as magnesium pyrophosphate, calcium pyrophosphate, calcium phosphate, calcium carbonate, magnesium phosphate, magnesium carbonate and magnesium oxide may be mentioned. Among these, an inorganic dispersant is preferable because further stable dispersion may be maintained.

When an inorganic dispersant is used, it is desirable to use a surfactant in combination. As such a surfactant, for example, sodium dodecyl benzenesulfonate and sodium α-olefin sulfonates may be mentioned.

The monomer mixture may be polymerized by heating, for example, at 60 to 150° C. for 2 to 40 hours. Polymerization may be carried out after absorption of the monomer mixture in the seed particles or during absorption of the monomer mixture in the seed particles. The monomer and the resin are almost the same in the amounts thereof.

The monomer mixture is normally polymerized in the presence of a polymerization initiator. The polymerization initiator is normally immersed in the seed particles at the same time as immersion of the monomer mixture.

For the polymerization initiator, there are no particular limitations so long as it has been conventionally used in the polymerization of styrene-based monomers and, for example, organic peroxides such as benzoyl peroxide, t-butyl peroxybenzoate, t-butyl peroxypivalate, t-butyl peroxy-2-ethylhexyl monocarbonate, t-butyl peroxyisopropylcarbonate, t-butyl peroxyacetate, 2,2-t-butyl peroxybutane, t-butylperoxy-3, 3, 5-trimethylhexanoate, di-t-butylperoxyhexahydroterephthalate, 2,5-dimethyl-2,5-bis(benzoylperoxy)hexane and dicumyl peroxide may be mentioned. The polymerization initiators may be used alone or in combination of two or more. The amount of the polymerization initiator used ranges, for example, 0.1 to 5 parts by mass with respect to 100 parts by mass of the monomer mixture.

In order to allow uniform absorption of the polymerization initiator into seed particles or particles still growing from seed particles, it is desirable to, when the polymerization initiator is added to the aqueous medium, preliminarily suspend or emulsify/disperse the polymerization initiator into the aqueous medium followed by addition to a dispersion or to preliminarily dissolve the polymerization initiator to the monomer mixture or a monomer in the monomer mixture followed by addition to the aqueous medium.

The composite resin particles of the present invention can be obtained by polymerizing the styrene-based monomer in at least two stages and appropriately setting the polymerization conditions thereof. More specifically, the styrene-based monomer is added at a temperature at which the polymerization initiator does not decompose, the reaction is maintained in the range of T1 to T1+15° C., wherein T1 is a 10-hour half-life temperature of the polymerization initiator, first polymerization is carried out in the range of T2−5° C. to T2+10° C., wherein T2 is a melting point of the polypropylene-based resin and then second polymerization is carried out.

### [Method for Producing Expandable Resin Particles]

The method for producing the expandable resin particles of the present invention is characterized in that butane/pentane in a mass ratio of 80/20 to 50/50 as the volatile blowing agent is immersed in the composite polyolefin-based resin particles. Immersion of the blowing agent may be carried out during or after polymerization of monomers of the resin by a publicly known method.

For example, immersion during polymerization may be carried out by carrying out polymerization reaction in a sealed container and pressing the blowing agent into the container. Immersion after polymerization may be carried out by pressing the blowing agent into a sealed container.

The conditions for immersion may be appropriately set according to the types of composite resin particles and the blowing agent and properties of the expandable resin particles to be obtained.

For example, if the temperature during immersion is low, the time required for immersion of the blowing agent in the composite resin particles may be extended to decrease production efficiency. On the other hand, if the temperature during immersion is high, composite resin particles may fuse to generate bound particles. Therefore, the temperature (° C.) during immersion is, for example, 50, 55, 60, 65, 70 or 80, preferably in the range of 50 to 80° C. and more preferably in the range of 60 to 70° C.

### [Pre-Expanded Particles]

The pre-expanded particles (also merely referred to as “expanded particles”) of the present invention can be obtained by expanding the expandable resin particles of the present invention.

More specifically, the expanded particles of the present invention can be obtained by expanding the expandable resin particles by introducing heated steam so as to obtain a desired bulk density.

The expanded particles may be directly used for filling materials such as cushions or may be used as a raw material of an expanded molded article for expansion in a cavity. When the expanded particles are used as a raw material of an expanded molded article, expansion for obtaining the expanded particles is normally referred to as “pre-expansion”.

The expanded particles preferably have a bulk density of 16 to 200 kg/m³.

If the bulk density of the expanded particles is less than 16 kg/m³, an obtained expanded molded article may shrink and the appearance thereof may deteriorate and the heat insulation and mechanical strength of the expanded molded article may decrease. On the other hand, if the bulk density of the expanded particles exceeds 200 kg/m³, merit in reducing weight of an expanded molded article may deteriorate.

The bulk density (kg/m³) of the expanded particles is, for example, 16, 20, 30, 40, 50, 60, 70, 80, 90, 100, 110, 120, 130, 140, 150, 160, 170, 180, 190 or 200.

Prior to expansion, powder metal soap such as zinc stearate may be applied on the surface of the expandable resin particles. By the application, binding of expandable resin particles during expansion step may be reduced.

### [Expanded Molded Article]

The expanded molded article of the present invention can be obtained by expanding and molding the pre-expanded particles of the present invention.

The expanded molded article is obtained by a publicly known method such that a mold of an expansion molding machine is fed with the expanded particles; and the expanded particles are heated again so that the particles are thermally fused during expansion.

The expanded molded article of the present invention preferably has a density of 16 to 200 kg/m³ and an average cell diameter of 50 to 600 μm.

If the density of the expanded molded article is lower than 16 kg/m³, the films of cells may become thin, resulting in generation of breakage of cells and reduction of impact resistance.

On the other hand, if the density of the expanded molded article exceeds 200 kg/m³, the expanded molded article may have an increased mass to increase transportation cost which is not preferable.

The density (kg/m³) of the expanded molded article is, for example, 16, 20, 25, 30, 40, 50, 60, 70, 80, 90, 100, 110, 120, 130, 140, 150, 160, 170, 180, 190 or 200.

The density of the expanded molded article is more preferably in the range of 25 to 100 kg/m³.

If the average cell diameter of the expanded molded article is lower than 50 μm, the films of cells may become thin, resulting in generation of breakage of cells, reduction in independent cell percentage and reduction in impact resistance in some cases.

On the other hand, if the average cell diameter of the expanded molded article exceeds 600 μm, smoothness of the surface of the molded article may be lost and appearance may deteriorate.

The average cell diameter (μm) of the expanded molded article is, for example, 50, 60, 70, 80, 90, 100, 125, 150, 175, 200, 225, 250, 275, 300, 350, 400, 450, 500, 550 or 600.

The average cell diameter of the expanded molded article is more preferably in the range of 80 to 300 μm.

### [Moldability]

Although depending on the molding conditions of the expanded particles, expanded particles preferably have a molding cycle of 120 to 250 seconds, a maximum pressure in mold of 0.12 to 0.18 MPa, a fusion ratio of 60 to 100% and 0 to 0 in a four-grade evaluation of the surface elongation as described hereinafter in Examples and it is desirable that the expanded particles maintain the satisfactorily properties for at least 1 month.

### [Life of Expanded Particles]

The residual gas amount in the expanded particles is preferably such that butane is 0.3 to 3.0% by mass and pentane is 0.3 to 1.5% by mass.

It is desirable that the expanded particles preferably have a dimension change ratio to mold of 5/1000 to 10/1000 and it is desirable that the expanded particles maintain the satisfactorily physical properties for at least 1 month.

### EXAMPLES

In the following, the present invention will be explained in detail through Examples and Comparative Examples. However, the following Examples are merely the exemplifications of the present invention and the present invention should not be limited only to these Examples.

In the Examples and the Comparative Examples, properties of the obtained composite resin particles, moldability upon production of an expanded molded article from the expanded particles obtained by pre-expanding the expandable resin particles, the life of expanded particles and properties of the obtained expanded molded article were evaluated as follows.

### [Content (% by Mass) of Gel of Composite Resin Particles]

The gel fraction (% by mass) is measured as follows.

In a 200-mL pear-shaped evaporating flask, 1.0 g of composite resin particles is accurately weighed, 100 mL of toluene and 0.03 g of boiling stone are added, a condenser tube is equipped and the flask is soaked in an oil bath maintained at 130° C. to reflux for 24 hours. Thereafter, while the solution in the pear-shaped evaporating flask is hot, the content is filtered through a 80-mesh (wire diameter 0.12 mm) metal wire cloth. The metal wire cloth with an insoluble resin is dried in a vacuum oven for 1 hour followed by drying at a gauge pressure of −0.06 MPa for 2 hours to remove toluene. After cooling the metal wire cloth to room temperature, the mass of the insoluble resin on the metal wire cloth is accurately weighed. The gel fraction (wt %) is determined according to the following calculation formula:

Gel fraction (% by mass)=mass of insoluble resin on metal wire cloth (g)/sample mass (g)×100

### [Average Particle Diameter (Mm) of Composite Resin Particles]

The average particle diameter is a value expressed as D50.

More specifically, about 25 g of sample is classified for 10 minutes by using a Ro-tap sieve shaker (manufactured by Sieve Factory Iida Co., Ltd.) with JIS standard sieves (JIS Z8801) having openings of 4.00 mm, 3.35 mm, 2.80 mm, 2.36 mm, 2.00 mm, 1.70 mm, 1.40 mm, 1.18 mm, 1.00 mm, 0.85 mm, 0.71 mm, 0.60 mm, 0.50 mm, 0.425 mm, 0.355 mm, 0.300 mm, 0.250 mm, 0.212 mm and 0.180 mm, in order to measure the mass of the sample on the wire sieves. From the results obtained, a cumulative mass distribution curve is prepared and an average particle diameter is indicated as a particle diameter at which the cumulative mass is 50% (median diameter).

### [Z-Average Molecular Weight and Mass Average Molecular Weight of a Polystyrene-Based Resin in Composite Resin Particles]

The Z-average molecular weight (Mz) and the mass average molecular weight (Mw) of a polystyrene-based resin mean the average molecular weight in terms of polystyrene measured by gel permeation chromatography (GPC). A method for measuring various average molecular weights of a polystyrene-based resin in an expanded molded article is hereinafter described. It should be noted that an expanded molded article is an assembly of composite resin particles and the average molecular weights do not change during production process of the expanded molded article from the composite resin particles, and thus the composite resin particles, the expandable particles and the pre-expanded particles have the same average molecular weights as those of the expanded molded article.

An expanded molded article is cut into slices of 0.3 mm thick, 100 mm long and 80 mm wide with a slicer (FK-4N, manufactured by Fujishima Koki Co., Ltd.) to obtain a sample for molecular weight measurement. More specifically, 3 mg of the sample is left in 10 mL of tetrahydrofuran (THF) for 24 hours for complete dissolution. The obtained solution is filtered through a 0.45-μm non-aqueous Chromatodisc (13N) manufactured by GL Sciences and then measured by chromatography under the following measurement conditions to determine the average molecular weight of the sample from a standard curve preliminarily prepared with standard polystyrenes. When the sample is not completely dissolved at the time of measurement, whether or not the sample is completely dissolved is further checked every 24 hours (up to 72 hours in total). When the sample does not completely dissolve after 72 hours, it is judged that the sample contains a cross-linked component and the molecular weight of the dissolved component is measured.

### (Measurement Conditions)

Device: HLC-8320GPC EcoSEC system (with a build-in RI detector) manufactured by Tosoh Corporation

Guard column: 1×TSK guard column Super HZ-H (4.6 mm I.D.×2 cm) manufactured by Tosoh Corporation

Column: 2×TSK gel Super HZM-H (4.6 mm I.D.×15 cm) manufactured by Tosoh Corporation

Column temperature: 40° C.

System temperature: 40° C.

Mobile phase: THF

Flow rate of mobile phase:
pump on the sample side=0.175 mL/min
pump on the reference side=0.175 mL/min

Detector: RI detector

Sample concentration: 0.3 g/L

Injection: 50 μL

Measuring time: 0 to 25 min

Running time: 25 min

Sampling pitch: 200 msec

### (Preparation of a Standard Curve)

Standard polystyrene samples for preparation of a standard curve were those having a mass average molecular weight of 5,480,000, 3,840,000, 355,000, 102,000, 37,900, 9,100, 2,630 and 500 from a product name “TSK standard POLYSTYRENE” manufactured by Tosoh Corporation and the one having a mass average molecular weight of 1,030,000 from a product name “Shodex STANDARD” manufactured by Showa Denko K.K.

The standard polystyrene samples for preparation of a standard curve were grouped into group A (1,030,000), group B (3,840,000, 102,000, 9,100 and 500) and group C (5,480,000, 355,000, 37,900 and 2,630). Thereafter, 5 mg of group A was weighed and dissolved in 20 mL of THF, 5 to 10 mg of each member in group B was weighed and dissolved in 50 mL of THF and 1 mg to 5 mg of each member in group C was also weighed and dissolved in 40 mL of THF. The standard curve of standard polystyrene was obtained by injecting 50 μL of each of prepared A, B and C solutions for measurement to obtain retention time and analyzing the calibration curve (cubic expression) obtained on a data analysis program specific for HLC-8320 GPC, GPC Work Station (EcoSEC-WS). The standard curve is used to calculate an average molecular weight.

### [Bulk Density (Kg/m³) and Bulk Expansion Ratio (Fold) of Pre-Expanded Particles]

The bulk density of the pre-expanded particles is measured as follows.

Pre-expanded particles are filled in a measuring cylinder up to a scale of 500 cm³. Filling is finished when the measuring cylinder is visually observed from the horizontal direction and even only one pre-expanded particle is reached to the scale of 500 cm³. Then the mass of the pre-expanded particles filled in the measuring cylinder is accurately weighed to two places of decimals to obtain the mass W (g). The bulk density of the pre-expanded particles is calculated from the following formula:

Bulk density (kg/m³)=W/500×1000

The bulk expansion ratio is a reciprocal of bulk density multiplied by 1000.

### [Expansion Ratio (Fold) of Expanded Molded Article]

A test piece of 10 cm×10 cm×3 cm (volume: V) is excised from the obtained expanded molded article and the mass W (g) thereof is weighed to two places of decimals

From the mass W of the obtained expanded molded article and the volume V of the expanded molded article, the expansion ratio (fold) is calculated by the following formula:

Expansion ratio of an expanded molded article=1/(bulk density of the expanded molded article)=1/(W/V)=V/W

### [Bulk Density (Kg/m³) of Expanded Molded Article]

According to the above result, the density (kg/m³) of an expanded molded article is calculated by the following formula:

Bulk density (kg/m³) of an expanded molded article=W/V×1000

### [Moldability/Molding Cycle (Sec)]

Expanded particles which are left to stand in an atmosphere of a temperature of 23° C. and relative humidity of 50% for 7 days after pre-expansion are filled into a rectangular cavity having an inner dimension of 300 mm×400 mm×30 mm (thickness) of a mold on an expansion beads automatic molding machine (manufactured by Sekisui Machinery Co., Ltd., ACE-3SP) and subjected to steam heating and cooling under the following conditions, an expanded molded article is removed from the mold when the surface pressure of the expanded molded article decreases to 0.02 MPa, the number of seconds required for heating and cooling is summed to evaluate the molding cycle.

(Molding Conditions)
Mold heating: 5 seconds
One-side heating: 10 seconds
Opposite side heating: 5 seconds
Double-sided heating: 15 seconds
Water cooling: 10 seconds
Setting steam pressure: 0.10 MPa
Surface pressure at removal: 0.02 MPa

The molding cycle is also evaluated in the same manner as above at 14 days, 21 days and 28 days after pre-expansion. When a molded article has low surface elongation, the article is molded while extending both-sided heating for 5 seconds. When a molded article has low fusion ratio, molding is carried out while increasing the setting steam pressure by 0.005 MPa.

The obtained molding cycle MC (sec) is evaluated according to the following standards.

250≦MC: Bad (x)

200≦MC<250: Good (Δ)

MC<200: Particularly good (◯)

### [Moldability/Maximum Pressure in Mold (MPa)]

An in-plane pressure detector is attached to the cavity of an expansion beads automatic molding machine (manufactured by Sekisui Machinery Co., Ltd., ACE-3SP) to measure maximum pressure in mold during the heating process. Generally, maximum pressure in mold is recorded during both-sided heating process.

### [Moldability/Fusion Ratio (%)]

The upper surface of 300 mm×400 mm of the rectangular expanded molded article having a thickness of 30 mm is scored with a cutter along the lateral direction with the line of 300 mm long and about 5 mm depth and the expanded molded article is fractioned into two along the score. For the expanded particles on the fracture surface of the fractioned expanded molded article, the number (a) of expanded particles fractured inside thereof and the number (b) of expanded particles fractured at the boundary face between the expanded articles are measured and the fusion ratio (%) is calculated based on the following formula:

Fusion ratio (%)=100×(a)/[(a)+(b)]

### [Moldability/Surface Elongation (Four-Grade Evaluation)]

Θ (excellent): the surface of the molded article is sufficiently elongated and there are no expanded particles with molten surface (there are no gaps between expanded particles, the surface of the molded article is very smooth and the molded article has very good appearance).

◯ (good): there are few gaps between expanded particles, the surface of the molded article is almost smooth and the molded article has good appearance.

Δ (acceptable): the surface of the molded article has insufficient elongation or there are expanded particles which have a molten surface, and the surface of the molded article has many gaps and the molded article has inferior appearance (without affecting the impact resistance).

x (not acceptable): the impact resistance is affected, or the surface of the molded article is not elongated such that it is difficult to evaluate the impact resistance or the molded article is shrunk.

### [Life of Expanded Particles/Residual Gas Amount (% by Mass) in Expanded Particles]

The amount (% by mass) of residual gas in pre-expanded particles is measured as follows.

The pre-expanded particles (about 20 mg) obtained by pre-expansion were accurately weighed and placed at an inlet of a pyrolyzer PYR-1A manufactured by Shimadzu Corporation. The pyrolyzer is purged with helium for about 15 seconds to discharge contaminated gas during placing the sample. After sealing the pyrolyzer, the sample is inserted to the core at 200° C., heated for 120 seconds to allow emission of gas which is measured and quantified under the following conditions.

Measurement device: Gas chromatograph GC-14B, pyrolyzer PYR-1A (manufactured by Shimadzu Corporation)

Column: Shimalite 60/80 NAW (Squalane 25%) 3 m×3 φ

Detector: FID

Measurement conditions: column temperature (70° C.), inlet temperature (110° C.), detector temperature (110° C.)

Carrier gas (N₂), N₂ flow rate (50 mL/min), absolute calibration method

### [Life of Expanded Particles/Dimension Change Ratio to Mold]

The dimensions of certain parts of a mold were measured, the dimensions of an expanded molded article corresponding to the certain parts were also measured, and the dimension change ratio was determined according to the following formula (1). The expanded molded article to be measured after molding is stored under an atmosphere of a temperature of 23° C. and relative humidity of 50% for 21 days or longer and then is measured in the same atmosphere. In the present Examples, the dimension of a lateral part (400 mm) of an expanded molded article of 300 mm×400 mm×30 mm thick was measured. The dimension of the mold was 404 mm.

Dimension change rate=((dimension of the mold)−(dimension of the molded article))/(dimension of the mold)×1000 (1)

The obtained dimension change ratio D to mold is evaluated by the following standards:

D≦10/1000: good (◯)

D>11/1000: bad (x)

### Example 1

### (Preparation of Composite Resin Particles)

(Preparation of Seed Particles)

A polyolefin-based resin (A) (manufactured by Tosoh Corporation, brand name: TOSOH-HMS, grade: 10S65B, 100 parts by mass) having a density of 940 kg/m³, an MFR of 2.0 g/10 min, a melting point of 126° C. and 43 parts by mass of a linear polyethylene (B) (manufactured by Japan Polyethylene Corporation, brand name: Harmorex, product number: NF444A) having a density of 912 kg/m³, an MFR of 2.0 g/10 min, a melting point of 121° C. as polyolefin-based resins and 0 parts by mass of a carbon black master batch (manufactured by Dow Chemical Japan Limited, product name: 28E-40) as a coloring agent were poured into a tumbler mixer and mixed for 10 min.

The obtained mixture was then supplied into an extruder (manufactured by Toshiba Machine Co., Ltd.; model No.: SE-65) and was heated and melted to be extruded in the form of granulated pellets by an underwater cutting method, obtaining spherical seed particles comprising polyolefin-based resin particles. The seed particles obtained were adjusted to be 0.40 to 0.60 mg/particle (average: 0.5 mg/particle) and an average particle diameter of about 0.9 mm.

In the following Examples and Comparative Examples, a heating rate and a cooling rate were 1° C./min during polymerization and preparation of expandable resin particles.

### (Preparation of Composite Resin Particles)

In a 5-liter autoclave equipped with a stirrer, 20 g of magnesium pyrophosphate and 0.15 g of sodium dodecyl benzenesulfonate were dispersed in 1.9 kg of pure water to obtain a dispersing medium.

In the dispersing medium was dispersed 760 g of the seed particles at 30° C., retained for 10 min and heated to 60° C. to obtain a suspension.

Then, 250 g of a styrene monomer, in which 0.55 g of dicumyl peroxide was already dissolved as a polymerization initiator, was added dropwise to the obtained suspension over 30 min. The mixture was retained for 60 minutes after dropwise addition to immerse the styrene monomer in the high-density polyethylene-based resin particles. After immersion, the reaction solution was then heated to 130° C. to allow polymerization (first polymerization) at the same temperature for 2 hours.

Then, to the suspension which was cooled to 120° C., an aqueous solution obtained by dissolving 0.65 g of sodium dodecyl benzenesulfonate in 0.1 kg of pure water was added and then 990 g of the styrene monomer, in which 4.46 g of dicumyl peroxide was already dissolved, was added dropwise over 4.5 hours. The sum of the styrene monomer was 150 parts by mass with respect to 100 parts by mass of the seed particles. After dropwise addition, 6.0 g of ethylene bis stearamide as a cell regulator was added and the reaction mixture was retained at 120° C. for 1 hour to immerse the styrene monomer in the high-density polyethylene-based resin particles. After immersion, the reaction mixture was heated to 140° C. and retained at the same temperature for 3 hours to allow polymerization (second polymerization). As a result of the polymerization, composite resin particles were obtained.

### (Preparation of Expandable Resin Particles)

The reaction solution was then cooled to 30° C. or lower and the composite resin particles were taken out from the autoclave. In a 5-liter autoclave equipped with a stirrer were poured 2 kg of the composite resin particles, 2 liters of water and 0.50 g of sodium dodecyl benzenesulfonate. As a blowing agent, 260 milliliters (150 g) of butane (n-butane:isobutane=7:3 (mass ratio)) and 150 g of pentane (n-pentane:isopentane=8:2 (mass ratio)) were added to the autoclave. After addition, the mixture was heated to 70° C. and stirred for 3 hours to give expandable particles.

The expandable particles were then cooled to 30° C. or lower, taken out from the autoclave and dried and dehydrated.

### (Preparation of Pre-Expanded Particles)

The obtained expandable particles were then immediately poured in an expansion machine and pre-expanded with 0.01 to 0.02 MPa of steam to obtain pre-expanded particles having a bulk density of 50 kg/m³.

### (Preparation of an Expanded Molded Article)

The obtained pre-expanded particles were left 7 days under an atmosphere of a temperature of 23° C. and relative humidity of 50% and filled into a mold having a size of 300 mm×400 mm×30 mm.

Thereafter the mold was heated by introducing 0.10 MPa of steam for 35 seconds and then was cooled until the surface pressure of the expanded molded article was decreased to 0.02 MPa, thereby obtaining the expanded molded article having a density of 50 kg/m³.

The results thus obtained are indicated in Tables 1 to 4 together with raw materials used and compounding amounts.

### Examples 2 and 3

Composite resin particles, expandable resin particles, pre-expanded particles and expanded molded articles were prepared in the same manner as in Example 1 except that the raw materials indicated in Tables 1 and 2 were used, and evaluated.

The results thus obtained are indicated in Tables 2 to 4 together with raw materials used and compounding amounts.

### Comparative Examples 1 to 3

Resin particles, expandable resin particles, pre-expanded particles and expanded molded articles were prepared in the same manner as in Example 1 except that the raw materials indicated in Tables 1 and 2 were used, and evaluated.

The results thus obtained are indicated in Tables 2 to 4 together with raw materials used and compounding amounts.

### Examples 4 to 7

Composite resin particles, expandable resin particles, pre-expanded particles and expanded molded articles were prepared in the same manner as in Example 1 except that the raw materials indicated in Tables 1 and 5 were used and in Examples 6 and 7, the steam pressure during molding was 0.15 MPa, and evaluated.

The results thus obtained are indicated in Tables 5 to 7 together with raw materials used and compounding amounts.

### Comparative Examples 4 to 8

Resin particles, expandable resin particles, pre-expanded particles and expanded molded articles were prepared in the same manner as in Example 1 except that the raw materials indicated in Tables 1 and 5 were used and in Comparative Examples 7 and 8, the steam pressure during molding was 0.15 MPa, and evaluated.

The results thus obtained are indicated in Tables 5 to 7 together with raw materials used and compounding amounts.

TABLE 1

| | | Resin | Density | MFR | Melting point |
|---|---|---|---|---|---|
| | | number | kg/m³ | g/10 min | ° C. |
| High-density | Manufactured by Tosoh Corporation, TOSOH-HMS | 1 | 936 | 2.6 | 123 |
| polyethylene | Grade: 09S53B | | | | |
| HDPE | Manufactured by Tosoh Corporation, TOSOH-HMS | 2 | 940 | 2.0 | 126 |
| | Grade: 10S65B | | | | |
| | Manufactured by Japan Polyethylene Corporation, Novatec | 3 | 960 | 1.0 | 135 |
| | HD Grade: HY540 | | | | |
| Linear low-density | Manufactured by Japan Polyethylene Corporation, Harmorex | A | 912 | 2.0 | 121 |
| polyethylene | Grade: NF444A | | | | |
| LLDPE | | | | | |
| Polypropylene | Manufactured by Prime Polymer Co., Ltd., Prime Polypro | B | 900 | 7.0 | 140 |
| PP | Grade: F-744NP | | | | |
| Ethylene-vinyl acetate | Japan Polyethylene Corporation, Novatec | C | 930 | 0.5 | 105 |
| copolymer resin | Grade: LV-115A | | | | |
| EVA | | | | | |
| Carbon black MB | Manufactured by Dow Chemical Japan Limited | — | — | — | 105 |
| | Product name: 28E-40 | | | | |

TABLE 2

| | | | | Examples | | | Comparative Examples | | |
|---|---|---|---|---|---|---|---|---|---|
| | | | | 1 | 2 | 3 | 1 | 2 | 3 |
| Compounding | HDPE/LLDPE ratio | | | 70/30 | 70/30 | 80/20 | 70/30 | 70/30 | 80/20 |
| ratio | Seed particles/PS ratio | | | 4/6 | 4/6 | 4/6 | 4/6 | 4/6 | 4/6 |
| Seed | HDPE | Resin 1 | Parts by | 0 | 0 | 0 | 0 | 0 | 0 |
| particles | | | mass | | | | | | |
| | | Resin 2 | Parts by | 100 | 100 | 100 | 100 | 100 | 100 |
| | | | mass | | | | | | |
| | | Resin 3 | Parts by | 0 | 0 | 0 | 0 | 0 | 0 |
| | | | mass | | | | | | |
| | LLDPE | Resin A | Parts by | 43 | 43 | 25 | 43 | 43 | 25 |
| | | | mass | | | | | | |

| | | | | | | | | |
|---|---|---|---|---|---|---|---|---|
| | Carbon black MB | Parts by | 0 | 0 | 0 | 0 | 0 | 0 |
| | | mass | | | | | | |
| Composite | Seed particles | Parts by | 100 | 100 | 100 | 100 | 100 | 100 |
| resin | | mass | | | | | | |
| particles | PS | Parts by | 150 | 150 | 150 | 150 | 150 | 150 |
| | | mass | | | | | | |
| | Content of gel | mass % | 0.8 | 0.8 | 0.6 | 0.8 | 0.8 | 1.1 |
| | Average particle diameter | mm | 1.27 | 1.27 | 1.28 | 1.27 | 1.27 | 1.28 |
| | Z average molecular weight Mz | ×10³ | 740 | 740 | 903 | 887 | 726 | 621 |
| | Mass average molecular weight Mw | ×10³ | 321 | 321 | 434 | 418 | 307 | 284 |
| Blowing | Butane | Parts by | 7.5 | 9 | 7.5 | 15 | 15 | 15 |
| agent | | mass | | | | | | |
| | Pentane | Parts by | 7.5 | 6 | 7.5 | 0 | 0 | 0 |
| | | mass | | | | | | |
| Pre-expanded | Bulk expansion ratio | Fold | 20 | 30 | 30 | 20 | 30 | 30 |
| particles | Bulk density | kg/m³ | 50 | 33.3 | 33.3 | 50 | 33.3 | 33.3 |
| Expanded | Expansion ratio | Fold | 20 | 30 | 30 | 20 | 30 | 30 |
| molded article | Density | kg/m³ | 50 | 33.3 | 33.3 | 50 | 33.3 | 33.3 |

HDPE: High-density polyethyelene
LLDPE: Linear low-density polyethylene
Carbon black MB: Carbon black master batch
PS: Polystyrene

TABLE 3

| | | | | Examples | | | Comparative Examples | | |
|---|---|---|---|---|---|---|---|---|---|
| | | | | 1 | 2 | 3 | 1 | 2 | 3 |
| Moldability | After | Molding cycle | Second | 230 | 210 | 215 | 320 | 280 | 290 |
| | 7 days | | | Δ | Δ | Δ | x | x | x |
| | | Maximum pressure in mold | MPa | 0.15 | 0.15 | 0.15 | 0.17 | 0.16 | 0.17 |
| | | Fusion ratio | % | 80 | 80 | 80 | 80 | 80 | 80 |
| | | Surface elongation | | Θ | Θ | Θ | Θ | Θ | Θ |
| | After | Molding cycle | Second | 210 | 190 | 195 | 280 | 240 | 245 |
| | 14 days | | | Δ | ∘ | ∘ | x | Δ | Δ |
| | | Maximum pressure in mold | MPa | 0.14 | 0.14 | 0.14 | 0.16 | 0.15 | 0.15 |
| | | Fusion ratio | % | 80 | 80 | 80 | 80 | 80 | 80 |
| | | Surface elongation | | ∘ | ∘ | ∘ | Θ | Θ | Θ |
| | After | Molding cycle | Second | 180 | 150 | 160 | 220 | 180 | 190 |
| | 21 days | | | ∘ | ∘ | ∘ | Δ | ∘ | ∘ |
| | | Maximum pressure in mold | MPa | 0.13 | 0.13 | 0.13 | 0.15 | 0.14 | 0.14 |
| | | Fusion ratio | % | 80 | 80 | 80 | 80 | 80 | 80 |
| | | Surface elongation | | ∘ | ∘ | ∘ | ∘ | ∘ | ∘ |
| | After | Molding cycle | Second | 160 | 136 | 143 | 180 | 160 | 170 |
| | 28 days | | | ∘ | ∘ | ∘ | ∘ | ∘ | ∘ |
| | | Maximum pressure in mold | MPa | 0.13 | 0.13 | 0.13 | 0.14 | 0.13 | 0.13 |
| | | Fusion ratio | % | 80 | 80 | 80 | 80 | 80 | 80 |
| | | Surface elongation | | ∘ | ∘ | ∘ | ∘ | ∘ | ∘ |

TABLE 4

| | | | | | Examples | | | Comparative Examples | | |
|---|---|---|---|---|---|---|---|---|---|---|
| | | | | | 1 | 2 | 3 | 1 | 2 | 3 |
| Life | After | Residual gas | Butane | mass % | 0.82 | 0.79 | 0.83 | 2.19 | 2.22 | 2.23 |
| of | 7 | Amount* | Pentane | mass % | 0.66 | 0.64 | 0.67 | 0.00 | 0.00 | 0.00 |
| expanded | days | Dimension change ratio** | | | 8/1000 | 8/1000 | 8/1000 | 7/1000 | 7/1000 | 7/1000 |
| particles | | | | | ∘ | ∘ | ∘ | ∘ | ∘ | ∘ |
| | After | Residual gas | Butane | mass % | 0.79 | 0.72 | 0.80 | 1.64 | 1.59 | 1.65 |
| | 14 | Amount* | Pentane | mass % | 0.64 | 0.62 | 0.64 | 0.00 | 0.00 | 0.00 |
| | days | Dimension change ratio** | | | 8/1000 | 8/1000 | 8/1000 | 7/1000 | 7/1000 | 7/1000 |
| | | | | | ∘ | ∘ | ∘ | ∘ | ∘ | ∘ |
| | After | Residual gas | Butane | mass % | 0.58 | 0.52 | 0.59 | 1.41 | 1.38 | 1.43 |
| | 21 | Amount* | Pentane | mass % | 0.57 | 0.51 | 0.58 | 0.00 | 0.00 | 0.00 |
| | days | Dimension change ratio** | | | 9/1000 | 9/1000 | 9/1000 | 8/1000 | 8/1000 | 8/1000 |
| | | | | | ∘ | ∘ | ∘ | ∘ | ∘ | ∘ |
| | After | Residual gas | Butane | mass % | 0.52 | 0.46 | 0.55 | 1.13 | 1.10 | 1.19 |
| | 28 | Amount* | Pentane | mass % | 0.55 | 0.52 | 0.56 | 0.00 | 0.00 | 0.00 |

| | | | | | | | |
|---|---|---|---|---|---|---|---|
| days | Dimension change ratio** | 9/1000 | 9/1000 | 9/1000 | 8/1000 | 8/1000 | 8/1000 |
| | | ∘ | ∘ | ∘ | ∘ | ∘ | ∘ |

*Expanded particles residual gas amount
**Dimension change ratio to mold

TABLE 5

| | | | | Examples | | | | Comparative Examples | | | | |
|---|---|---|---|---|---|---|---|---|---|---|---|---|
| | | | | 4 | 5 | 6 | 7 | 4 | 5 | 6 | 7 | 8 |
| Compounding | HDPE/LLDPE ratio | | | 100/0 | 100/0 | 60/40 | 60/40 | 100/0 | 100/0 | 100/0 | 60/40 | 60/40 |
| ratio | Seed particles/PS ratio | | | 3/7 | 3/7 | 3/7 | 3/7 | 3/7 | 3/7 | 3/7 | 3/7 | 3/7 |
| Seed | HDPE | Resin 1 | Parts by | 100 | 100 | 0 | 0 | 100 | 100 | 100 | 0 | 0 |
| particles | | | mass | | | | | | | | | |
| | | Resin 2 | Parts by | 0 | 0 | 0 | 0 | 0 | 0 | 0 | 0 | 0 |
| | | | mass | | | | | | | | | |
| | | Resin 3 | Parts by | 0 | 0 | 100 | 100 | 0 | 0 | 0 | 100 | 100 |
| | | | mass | | | | | | | | | |
| | LLDPE | Resin A | Parts by | 0 | 0 | 67 | 67 | 0 | 0 | 0 | 67 | 67 |
| | | | mass | | | | | | | | | |

| | | | | | | | | | | | |
|---|---|---|---|---|---|---|---|---|---|---|---|
| | Carbon black MB | Parts by | 11 | 11 | 22 | 22 | 11 | 11 | 11 | 22 | 22 |
| | | mass | | | | | | | | | |
| Composite resin | Seed particles | Parts by | 100 | 100 | 100 | 100 | 100 | 100 | 100 | 100 | 100 |
| particles | | mass | | | | | | | | | |
| | PS | Parts by | 233 | 233 | 233 | 233 | 233 | 233 | 233 | 233 | 233 |
| | | mass | | | | | | | | | |
| | Content of gel | mass % | 0.6 | 0.6 | 1.6 | 1.3 | 0.6 | 0.6 | 0.6 | 1.5 | 1.5 |
| | Average particle diameter | mm | 1.3 | 1.3 | 1.31 | 1.3 | 1.3 | 1.3 | 1.3 | 1.29 | 1.29 |
| | Z average molecular weight Mz | ×10³ | 932 | 932 | 712 | 712 | 720 | 720 | 720 | 901 | 901 |
| | Mass average molecular weight Mw | ×10³ | 422 | 422 | 358 | 358 | 348 | 348 | 348 | 433 | 433 |
| Blowing | Butane | Parts by | 7.5 | 9 | 7.5 | 10.5 | 15 | 15 | 6 | 0 | 0 |
| agent | | mass | | | | | | | | | |
| | Pentane | Parts by | 7.5 | 6 | 7.5 | 4.5 | 0 | 0 | 9 | 15 | 15 |
| | | mass | | | | | | | | | |
| Pre-expanded | Bulk expansion ratio | Fold | 20 | 30 | 20 | 30 | 20 | 30 | 30 | 20 | 30 |
| particles | Bulk density | kg/m³ | 50 | 33.3 | 50 | 33.3 | 50 | 33.3 | 33.3 | 50 | 33.3 |
| Expanded | Expansion ratio | Fold | 20 | 30 | 20 | 30 | 20 | 30 | 30 | 20 | 30 |
| molded | Density | kg/m³ | 50 | 33.3 | 50 | 33.3 | 50 | 33.3 | 33.3 | 50 | 33.3 |
| article | | | | | | | | | | | |

HDPE: high-density polyethylene
LLDPE: linear low-density polyethylene
Carbon black MB: carbon black master batch
PS: polystyrene

TABLE 6

| | | | | Examples | | | | Comparative Examples | | | | |
|---|---|---|---|---|---|---|---|---|---|---|---|---|
| | | | | 4 | 5 | 6 | 7 | 4 | 5 | 6 | 7 | 8 |
| Moldability | After | Molding cycle | Second | 248 | 240 | 248 | 245 | 340 | 320 | 220 | 238 | 230 |
| | 7 days | | | Δ | Δ | Δ | Δ | x | x | Δ | Δ | Δ |
| | | Maximum pressure in mold | MPa | 0.15 | 0.15 | 0.19 | 0.19 | 0.16 | 0.16 | 0.14 | 0.18 | 0.18 |
| | | Fusion ratio | % | 80 | 80 | 80 | 80 | 80 | 80 | 80 | 80 | 80 |
| | | Surface elongation | | Θ | Θ | Θ | Θ | Θ | Θ | Θ | Θ | Θ |
| | After | Molding cycle | Second | 220 | 210 | 225 | 220 | 290 | 270 | 200 | 200 | 190 |
| | 14 days | | | Δ | Δ | Δ | Δ | x | x | Δ | Δ | ∘ |
| | | Maximum pressure in mold | MPa | 0.15 | 0.15 | 0.19 | 0.19 | 0.15 | 0.15 | 0.13 | 0.17 | 0.17 |
| | | Fusion ratio | % | 80 | 80 | 80 | 80 | 80 | 80 | 80 | 80 | 80 |
| | | Surface elongation | | ∘ | ∘ | ∘ | ∘ | Θ | Θ | ∘ | ∘ | ∘ |
| | After | Molding cycle | Second | 190 | 185 | 195 | 200 | 240 | 230 | 180 | 180 | 170 |
| | 21 days | | | ∘ | ∘ | ∘ | Δ | Δ | Δ | ∘ | ∘ | ∘ |
| | | Maximum pressure in mold | MPa | 0.14 | 0.14 | 0.18 | 0.18 | 0.14 | 0.14 | 0.12 | 0.16 | 0.16 |
| | | Fusion ratio | % | 80 | 80 | 80 | 80 | 80 | 80 | 80 | 80 | 80 |
| | | Surface elongation | | ∘ | ∘ | ∘ | ∘ | ∘ | ∘ | ∘ | Δ | Δ |
| | After | Molding cycle | Second | 175 | 170 | 180 | 185 | 210 | 200 | 170 | 165 | 150 |
| | 28 days | | | ∘ | ∘ | ∘ | ∘ | Δ | Δ | ∘ | ∘ | ∘ |
| | | Maximum pressure in mold | MPa | 0.13 | 0.13 | 0.18 | 0.18 | 0.13 | 0.13 | 0.12 | 0.15 | 0.15 |
| | | Fusion ratio | % | 80 | 80 | 80 | 80 | 80 | 80 | 80 | 80 | 80 |
| | | Surface elongation | | ∘ | ∘ | ∘ | ∘ | ∘ | ∘ | Δ | x | x |

TABLE 7

| | | | | | Examples | | | | Comparative Examples | | | | |
|---|---|---|---|---|---|---|---|---|---|---|---|---|---|
| | | | | | 4 | 5 | 6 | 7 | 4 | 5 | 6 | 7 | 8 |
| Life | After | Residual gas | Butane | mass % | 2.61 | 3.13 | 2.58 | 3.61 | 4.52 | 4.31 | 1.47 | 0.00 | 0.00 |
| of | 7 | amount* | Pentane | mass % | 1.72 | 1.38 | 1.75 | 1.00 | 0.00 | 0.00 | 2.20 | 3.81 | 3.68 |
| expanded | days | Dimension change ratio** | | | 7/1000 | 7/1000 | 7/1000 | 7/1000 | 7/1000 | 7/1000 | 9/1000 | 9/1000 | 10/1000 |
| particles | | | | | ∘ | ∘ | ∘ | ∘ | ∘ | ∘ | ∘ | ∘ | ∘ |
| | After | Residual gas | Butane | mass % | 1.86 | 2.23 | 1.88 | 2.60 | 3.51 | 3.43 | 1.15 | 0.00 | 0.00 |
| | 14 | amount* | Pentane | mass % | 1.23 | 0.98 | 1.25 | 0.77 | 0.00 | 0.00 | 1.72 | 3.02 | 2.87 |
| | days | Dimension change ratio** | | | 7/1000 | 8/1000 | 7/1000 | 7/1000 | 7/1000 | 7/1000 | 10/1000 | 10/1000 | 11/1000 |
| | | | | | ∘ | ∘ | ∘ | ∘ | ∘ | ∘ | ∘ | ∘ | x |
| | After | Residual gas | Butane | mass % | 0.99 | 1.17 | 1.01 | 1.40 | 2.42 | 2.47 | 0.79 | 0.00 | 0.00 |
| | 21 | amount* | Pentane | mass % | 1.01 | 0.90 | 0.97 | 0.59 | 0.00 | 0.00 | 1.19 | 2.06 | 1.98 |
| | days | Dimension change ratio** | | | 8/1000 | 8/1000 | 8/1000 | 8/1000 | 8/1000 | 8/1000 | 11/1000 | 11/1000 | 12/1000 |
| | | | | | ∘ | ∘ | ∘ | ∘ | ∘ | ∘ | x | x | x |
| | After | Residual gas | Butane | mass % | 0.94 | 1.12 | 0.97 | 1.38 | 1.34 | 1.31 | 0.39 | 0.00 | 0.00 |
| | 28 | amount* | Pentane | mass % | 0.95 | 0.77 | 0.94 | 0.56 | 0.00 | 0.00 | 0.59 | 0.95 | 0.98 |

| | | | | | | | | | | |
|---|---|---|---|---|---|---|---|---|---|---|
| days | Dimension change ratio** | 8/1000 | 9/1000 | 9/1000 | 8/1000 | 8/1000 | 8/1000 | 12/100 | 12/1000 | 13/1000 |
| | | ∘ | ∘ | ∘ | ∘ | ∘ | ∘ | | x | x |

*Expanded particles residual gas amount
**Dimension change ratio to mold

### Examples 8 to 11

Seed particles were obtained as follows in Examples 8 to 11 and Comparative Examples 9 to 11.

A polypropylene resin (B) (manufactured by Prime Polymer Co., Ltd., grade: F-744NP, density: 900 kg/m³, MFR: 7.0 g/10 min, melting point: 140° C., 100 parts by mass) was supplied into an extruder and was melted and kneaded to be granulated by an underwater cutting method to obtain polypropylene resin particles having oval shape (egg shape). The resin particles had an average weight of 0.6 mg.

An ethylene-vinyl acetate copolymer resin (C) (manufactured by Japan Polyethylene Corporation, grade: LV-115A, density: 930 kg/m³, MFR: 0.5 g/10 min, melting point: 105° C., 100 parts by mass) was supplied into an extruder and was melted and kneaded to be granulated by an underwater cutting method to obtain ethylene-vinyl acetate copolymer resin particles having oval shape (egg shape). The resin particles had an average weight of 0.6 mg.

A linear low-density polyethylene resin (A) (manufactured by Japan Polyethylene Corporation, brand name: Harmorex, grade: NF444A, density: 912 kg/m³, MFR: 2.0 g/10 min, melting point:121° C., 100 parts by mass) was supplied into an extruder and was melted and kneaded to be granulated by an underwater cutting method to obtain linear low-density polyethylene resin particles having oval shape (egg shape). The resin particles had an average weight of 0.6 mg.

In Examples 8 and 9, composite resin particles, expandable resin particles, pre-expanded particles and expanded molded articles were prepared in the same manner as in Example 1 except that the steam pressure during molding was 0.25 MPa and the temperature after completion of the first polymerization was 125° C. instead of 120° C., and evaluated.

In Example 10, composite resin particles, expandable resin particles, pre-expanded particles and an expanded molded article were prepared in the same manner as in Example 1 except that the steam pressure during molding was 0.08 MPa, the temperature after completion of the first polymerization was 90° C. instead of 120° C. and a polymerization initiator during the second polymerization was benzoyl peroxide instead of dicumyl peroxide, and evaluated.

In Example 11, composite resin particles, expandable resin particles, pre-expanded particles and an expanded molded article were prepared in the same manner as in Example 1 except that the steam pressure during molding was 0.09 MPa, the temperature after completion of the first polymerization was 115° C. instead of 120° C. and a polymerization initiator during the second polymerization was t-butyl peroxybenzoate instead of dicumyl peroxide, and evaluated.

The results thus obtained are indicated in Tables 8 to 10 together with raw materials used and compounding amounts.

### Comparative Examples 9 to 11

In Comparative Example 9, resin particles, expandable resin particles, pre-expanded particles and an expanded molded article were prepared in the same manner as in Example 1 except that the steam pressure during molding was 0.25 MPa, and evaluated.

The results thus obtained are indicated in Tables 8 to 10 together with raw materials used and compounding amounts.

In Comparative Example 10, composite resin particles, expandable resin particles, pre-expanded particles and an expanded molded article were prepared in the same manner as in Example 1 except that the steam pressure during molding was 0.08 MPa, the temperature after completion of the first polymerization was 90° C. instead of 120° C. and a polymerization initiator during the second polymerization was benzoyl peroxide instead of dicumyl peroxide, and evaluated.

In Comparative Example 11, composite resin particles, expandable resin particles, pre-expanded particles and an expanded molded article were prepared in the same manner as in Example 1 except that the steam pressure during molding was 0.09 MPa, the temperature after completion of the first polymerization was 115° C. instead of 120° C. and a polymerization initiator during the second polymerization was t-butyl peroxybenzoate instead of dicumyl peroxide, and evaluated.

The results in Tables 2 to 7 and 8 to 10 exhibit that expandable resin particles of Example 1 to 7 and 8 to 11 can realize both good moldability (molding cycle) and life of expanded particles compared to the expandable resin particles of Comparative Examples 1 to 8 and 9 to 11.

TABLE 8

| | | | | Examples | | | | Comparative Examples | | |
|---|---|---|---|---|---|---|---|---|---|---|
| | | | | 8 | 9 | 10 | 11 | 9 | 10 | 11 |
| Compounding | HDPE/LLDPE ratio | | | — | — | — | — | — | — | — |
| ratio | Seed particles/PS ratio | | | 4/6 | 4/6 | 38/62 | 2/8 | 4/6 | 38/62 | 2/8 |
| Seed | HDPE | Resin 1 | Parts by | 0 | 0 | 0 | 0 | 0 | 0 | 0 |
| particles | | | mass | | | | | | | |
| | | Resin 2 | Parts by | 0 | 0 | 0 | 0 | 0 | 0 | 0 |
| | | | mass | | | | | | | |
| | | Resin 3 | Parts by | 0 | 0 | 0 | 0 | 0 | 0 | 0 |
| | | | mass | | | | | | | |
| | LLDPE | Resin A | Parts by | 0 | 0 | 0 | 100 | 0 | 0 | 100 |
| | | | mass | | | | | | | |
| | PP | Resin B | Parts by | 100 | 100 | 0 | 0 | 100 | 0 | 0 |
| | | | mass | | | | | | | |
| | EVA | Resin C | Parts by | 0 | 0 | 100 | 0 | 0 | 100 | 0 |
| | | | mass | | | | | | | |

| | | | | | | | | | |
|---|---|---|---|---|---|---|---|---|---|
| | Carbon black MB | Parts by | 0 | 0 | 0 | 0 | 0 | 0 | 0 |
| | | mass | | | | | | | |
| Composite resin | Seed particles | Parts by | 100 | 100 | 100 | 100 | 100 | 100 | 100 |
| particles | | mass | | | | | | | |
| | PS | Parts by | 150 | 150 | 163 | 400 | 150 | 163 | 400 |
| | | mass | | | | | | | |
| | Content of gel | mass % | 0.7 | 0.7 | 21.6 | 0.6 | 0.7 | 21.6 | 0.6 |
| | Average particle diameter | mm | 1.41 | 1.41 | 1.22 | 1.44 | 1.41 | 1.22 | 1.44 |
| | Z average molecular weight Mz | ×10³ | 950 | 950 | 977 | 712 | 950 | 977 | 712 |
| | Mass average molecular weight Mw | ×10³ | 361 | 361 | 383 | 358 | 361 | 383 | 358 |
| Blowing | Butane | Parts by | 14.4 | 12.6 | 5.25 | 12.6 | 18 | 10.5 | 18 |
| agent | | mass | | | | | | | |
| | Pentane | Parts by | 3.6 | 5.4 | 5.25 | 5.4 | 0 | 0 | 0 |
| | | mass | | | | | | | |
| Pre-expanded | Bulk expansion ratio | Fold | 35 | 35 | 10 | 60 | 35 | 10 | 60 |
| particles | Bulk density | kg/m³ | 28.6 | 28.6 | 100.0 | 167 | 28.6 | 100.0 | 16.7 |
| Expanded | Expansion ratio | Fold | 35 | 35 | 10 | 60 | 35 | 10 | 60 |
| molded | Density | kg/m³ | 28.6 | 28.6 | 100.0 | 16.7 | 28.6 | 100.0 | 16.7 |
| article | | | | | | | | | |

HDPE: high-density polythylene
LLDPE: linear low-density polyethylene
PP: polypropylene
EVA: ethylene-vinyl acetate copolymer resin
Carbon black MB: carbon black master batch
PS: polystyrene

TABLE 9

| | | | | Examples | | | | Comparative Examples | | |
|---|---|---|---|---|---|---|---|---|---|---|
| | | | | 9 | 10 | 11 | 12 | 9 | 10 | 11 |
| Moldability | After | Molding cycle | Second | 245 | 230 | 203 | 217 | 300 | 252 | 285 |
| | 7 days | | | Δ | Δ | Δ | Δ | x | x | x |
| | | Maximum pressure in mold | MPa | 0.31 | 0.30 | 0.14 | 0.14 | 0.33 | 0.15 | 0.14 |
| | | Fusion ratio | % | 80 | 80 | 80 | 80 | 80 | 80 | 80 |
| | | Surface elongation | | Θ | Θ | Θ | Θ | Θ | Θ | Θ |
| | After | Molding cycle | Second | 220 | 210 | 170 | 193 | 260 | 222 | 243 |
| | 14 days | | | Δ | Δ | ∘ | ∘ | x | Δ | Δ |
| | | Maximum pressure in mold | MPa | 0.30 | 0.29 | 0.14 | 0.13 | 0.32 | 0.15 | 0.14 |
| | | Fusion ratio | % | 80 | 80 | 80 | 80 | 80 | 80 | 80 |
| | | Surface elongation | | Θ | Θ | Θ | Θ | Θ | Θ | Θ |
| | After | Molding cycle | Second | 190 | 180 | 133 | 140 | 240 | 160 | 168 |
| | 21 days | | | ∘ | ∘ | ∘ | ∘ | Δ | ∘ | ∘ |
| | | Maximum pressure in mold | MPa | 0.28 | 0.28 | 0.13 | 0.13 | 0.30 | 0.14 | 0.13 |
| | | Fusion ratio | % | 80 | 80 | 80 | 80 | 80 | 80 | 80 |
| | | Surface elongation | | ∘ | ∘ | ∘ | ∘ | ∘ | Θ | Θ |
| | After | Molding cycle | Second | 180 | 170 | 129 | 130 | 220 | 149 | 156 |
| | 28 days | | | ∘ | ∘ | ∘ | ∘ | ∘ | ∘ | ∘ |
| | | Maximum pressure in mold | MPa | 0.27 | 0.27 | 0.13 | 0.13 | 0.29 | 0.14 | 0.13 |
| | | Fusion ratio | % | 80 | 80 | 80 | 80 | 80 | 80 | 80 |
| | | Surface elongation | | ∘ | ∘ | ∘ | ∘ | ∘ | Θ | Θ |

TABLE 10

| | | | | | Examples | | | | Comparative Examples | | |
|---|---|---|---|---|---|---|---|---|---|---|---|
| | | | | | 9 | 10 | 11 | 12 | 9 | 10 | 11 |
| Life | After | Residual gas | Butane | mass % | 1.39 | 1.17 | 0.89 | 1.20 | 2.57 | 2.19 | 2.37 |
| of | 7 | amount* | Pentane | mass % | 0.75 | 0.85 | 0.74 | 1.17 | 0.00 | 0.00 | 0.00 |
| expanded | days | Dimension change ratio** | | | 9/1000 | 9/1000 | 9/1000 | 9/1000 | 8/1000 | 8/1000 | 8/1000 |
| particles | | | | | ∘ | ∘ | ∘ | ∘ | ∘ | ∘ | ∘ |
| | After | Residual gas | Butane | mass % | 1.00 | 0.93 | 0.72 | 0.98 | 1.64 | 1.64 | 1.95 |
| | 14 | amount* | Pentane | mass % | 0.54 | 0.58 | 0.62 | 0.94 | 0.00 | 0.00 | 0.00 |
| | days | Dimension change ratio** | | | 9/1000 | 9/1000 | 9/1000 | 9/1000 | 9/1000 | 9/1000 | 9/1000 |
| | | | | | ∘ | ∘ | ∘ | ∘ | ∘ | ∘ | ∘ |
| | After | Residual gas | Butane | mass % | 0.54 | 0.53 | 0.52 | 0.76 | 1.41 | 1.23 | 1.41 |
| | 21 | amount* | Pentane | mass % | 0.33 | 0.32 | 0.51 | 0.72 | 0.00 | 0.00 | 0.00 |
| | days | Dimension change ratio** | | | 10/1000 | 10/1000 | 10/1000 | 9/1000 | 9/1000 | 9/1000 | 9/1000 |
| | | | | | ∘ | ∘ | ∘ | ∘ | ∘ | ∘ | ∘ |
| | After | Residual gas | Butane | mass % | 0.53 | 0.45 | 0.46 | 0.56 | 1.13 | 1.00 | 1.12 |
| | 28 | amount* | Pentane | mass % | 0.24 | 0.31 | 0.42 | 0.54 | 0.00 | 0.00 | 0.00 |

| | | | | | | | | |
|---|---|---|---|---|---|---|---|---|
| days | Dimension change ratio** | 10/1000 | 10/1000 | 10/1000 | 10/1000 | 10/1000 | 10/1000 | 9/1000 |
| | | ∘ | ∘ | ∘ | ∘ | ∘ | ∘ | ∘ |

*Expanded particles residual gas amount
**Dimension change ratio to mold

1. Expandable styrene composite polyolefin-based resin particles which comprise styrene composite polyolefin-based resin particles containing a polyolefin-based resin and 100 to 400 parts by mass of a styrene-based resin with respect to 100 parts by mass of the polyolefin-based resin and comprise butane/pentane in a mass ratio of 80/20 to 50/50 as a volatile blowing agent.

2. The expandable styrene composite polyolefin-based resin particles according to claim 1, wherein the volatile blowing agent is contained at a proportion of 9 to 18% by mass with respect to the styrene composite polyolefin-based resin.

3. The expandable styrene composite polyolefin-based resin particles according to claim 1, wherein the volatile blowing agent is a mixture of butane selected from n-butane and isobutene, and pentane selected from n-pentane, isopentane and neopentane.

4. The expandable styrene composite polyolefin-based resin particles according to claim 1, wherein when about 1 g of the styrene composite polyolefin-based resin particles is dissolved in 100 ml of refluxed toluene, content of insoluble gel is less than 5% by mass.

5. The expandable styrene composite polyolefin-based resin particles according to claim 1, wherein the styrene composite polyolefin-based resin particles have an average particle diameter of 1.0 to 2.0 mm.

6. The expandable styrene composite polyolefin-based resin particles according to claim 1, wherein the styrene composite polyolefin-based resin particles contain 0.5 to 2.5% by mass of carbon black as a coloring agent with respect to the styrene composite polyolefin-based resin particles.

7. The expandable styrene composite polyolefin-based resin particles according to claim 1, wherein the polyolefin-based resin is formed with a first polyethylene-based resin having medium to high density in the range of 925 to 965 kg/m³ and a second linear polyethylene-based resin having a density that is lower than that of the first polyethylene-based resin.

8. Pre-expanded particles obtained by expanding the expandable styrene composite polyolefin-based resin particles according to claim 1.

9. An expanded molded article obtained by expansion molding of the pre-expanded particles according to claim 8.

10. A method for producing the expandable styrene composite polyolefin-based resin particles according to claim 1, comprising immersing butane/pentane in a mass ratio of 80/20 to 50/50 as a volatile blowing agent in the styrene composite polyolefin-based resin particles.
